(19) United States
(12) Patent Application Publication
(10) Pub. No.: US 2020/0193745 A1
(43) Pub. Date: Jun. 18, 2020

(54) WIRELESS CONTROL OF LINEAR ELECTROMAGNETIC ACTUATOR CHILD PROOF SYSTEM

(71) Applicant: RICHARD JOSEPH MORRIS, Discovery Bay, CA (US)

(72) Inventor: RICHARD JOSEPH MORRIS, Discovery Bay, CA (US)

(21) Appl. No.: 16/403,499

(22) Filed: May 4, 2019

Related U.S. Application Data
(60) Provisional application No. 62/780,236, filed on Dec. 15, 2018.

(51) Int. Cl. G07C 9/00; F16K 31/06

(52) U.S. Cl. CPC G07C 9/0073; G07C 2009/00769; F16K 31/0675

(57) ABSTRACT

A system for remotely locking and unlocking multiple storage units simultaneously or selectively (e.g. cabinet doors & drawers). The system works via a plurality of electromagnetic locking devices (“linear electromagnetic actuators”) coupled to the controller. The system further comprises a remote control unit wirelessly coupled to the controller. The remote control unit sends instructions to the controller to lock/unlock the electromagnetic locking devices to facilitate the locking and unlocking of any particular electromagnetic device associated with the controller. The linear electromagnetic actuator can incorporate electromagnets in addition to (or in lieu of) linear electromagnets and may utilize push/pull linear electromagnetic actuators. In some instances, the system may require a linear electromagnetic actuator with an angled lock looking style like a door latch/lock that slides onto the hole-port location; a magnet style can be utilized as well.

### CROSS-REFERENCE TO RELATED APPLICATIONS

This application claims priority to no prior applications.

### FIELD OF THE DISCLOSURE

The disclosure relates to the field of automated remote computer/app-controlled linear electromagnetic actuator, safety, childproofing, alert and information systems.

### BACKGROUND

The purpose of this system is to add convenience and safety to the daily life of parents, teachers, nurseries, day care providers, doctors offices, etc. in order to prevent children or elderly to be able to come in contact with items that may present a health risk for them or to prevent from theft. This system will work in a manor as to give complete control by ensuring kitchen and bathroom cabinet drawers, doors, medicine cabinets, nightstands, dressers and desks are secured lock with a push of a switch, wireless remote or an app from mobile phone or tablet.

The kitchen cabinet doors and drawers within reach of children fitted with Childproof Linear Electromagnetic Actuator locking system will work by enabling the user full control to unlock all kitchen and bathroom cabinet drawers and doors at same time to eliminate the hassle of fighting with existing baby proofed doors and drawers by unlocking one at a time.

The system is designed to work in a manor as when there are no activities taking place in kitchen, bathroom, etc., they will lock all the doors and drawers simultaneously by pushing a switch, remote control or using an app from their phone or tablet. When the adult decides it time to work in the kitchen to prepare a meal they will unlock all doors and drawers simultaneously in the same manor by pushing the unlock switch, using remote control or using the app to unlock. The user(s) will also have the ability to see if all doors are locked via a light that would be either integrated in the switch or a standalone light or via the app on the mobile phone, tablet or computer. (If there is the need to keep all doors and drawers locked because a child is around and individual doors or drawers need to be open at a time it can be done either through the app or a remote control).

The system is designed to be operable in the event of a power failure or a defect from the system. There will be an unlock tool that can be utilized in the event of power or system failure. There will be predetermined dimensions of how much the door or drawer will be allowed to open in the locked position to allow insertion of the unlock tool to release or retract the linear electromagnetic actuator.

### SUMMARY OF THE INVENTION

The instant invention is a system for remotely locking and unlocking multiple storage units (e.g. drawers, cabinets) simultaneously or selectively. The storage units can include, for example, cabinet doors and drawers in the kitchen, living room, bathrooms, and so on.

The system comprises a controller, described infra and supra.

The system works via a plurality of electromagnetic locking devices (herein “linear electromagnetic actuators”) coupled to the controller. The system further comprises a remote control unit that is [preferred embodiment] wirelessly coupled to the controller.

The remote control unit allows the user to send instructions to the controller to either simultaneously lock or unlock all the electromagnetic locking devices associated with the controller or facilitate the locking and unlocking of any particular electromagnetic device associated with the controller.

The system is designed to work with different types of linear electromagnetic actuators. The linear electromagnetic actuator can incorporate electromagnets in addition to (or in lieu of) linear electromagnets based on ease of installation for example linear electromagnetic actuator can be various styles and types based on clearances of the application (drawers/cabinets, doors etc) certain demotions or clearances may require push pull linear electromagnetic actuator. In some instances, the system may require a linear electromagnetic actuator with an angled lock looking style like a door latch/lock that will slide on to the hole port location, a magnet style can be utilized as well.

### BRIEF DESCRIPTION OF THE DRAWINGS

The drawings described herein are for illustrative purposes only and illustrate only selected embodiments of the present invention. The enclosed drawings are not intended to limit the scope of the present disclosure.

FIG. 1 illustrates a schematic representation of the system, wherein controller is represented by reference no.103, electromagnetic locking devices are represented by reference no. 101, and indication means (e.g. LED) is represented by reference no. 107.

FIG. 2 illustrates a schematic representation of a wireless embodiment of the system, wherein 201 represents the remote control unit, 203 represents the controller, and 204 represents wireless switch with an integral transmitter to transmit switch of door/drawer position to wireless electronic controller to provide an indication on the apps or the light in the wireless electronic controller.

FIG. 3 illustrates a schematic view of a wireless electromagnetic locking device, wherein 301 depicts the locking device, 303 represents the receiver, and 304 represents the battery/power supply.

FIG. 4 illustrates a block diagram of the system depicting wired and wireless electromagnetic locking devices as coupled to the controller.

FIG. 5 is an illustration of exemplary components of the linear electromagnetic hardware.

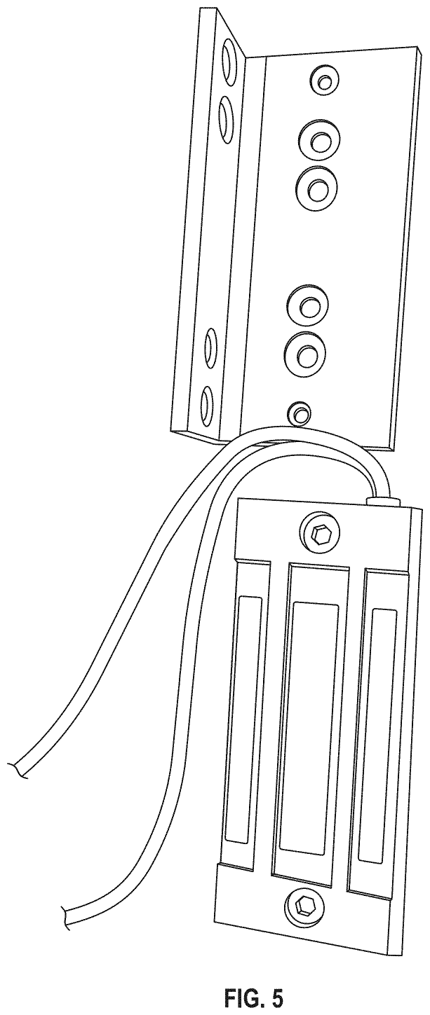

FIG. 6 is a solenoid actuator, herein used to effectuate the electromagnetic locking device(s) in the instant invention.

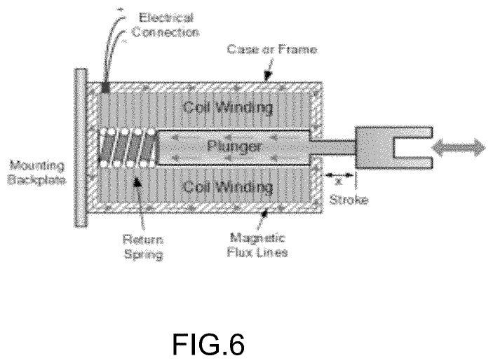

FIG. 7 is a non-solenoid electromagnetic actuator, herein used to effectuate the locking device(s) in the instant invention.

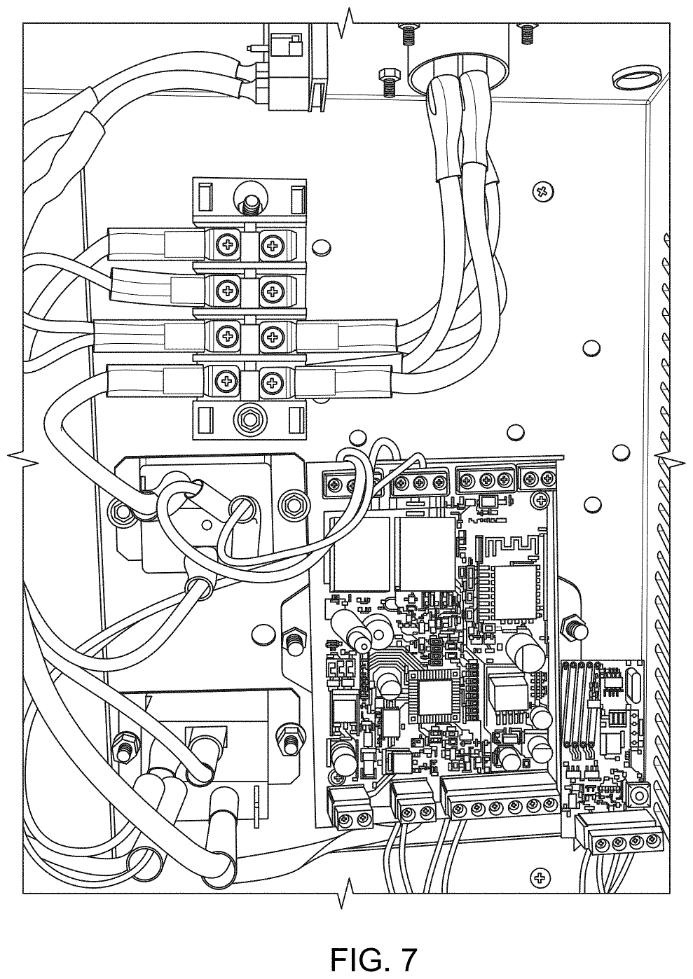

FIG. 8 is a WiFi-controlled PCB with two channels, Wireless Wiegand system control.

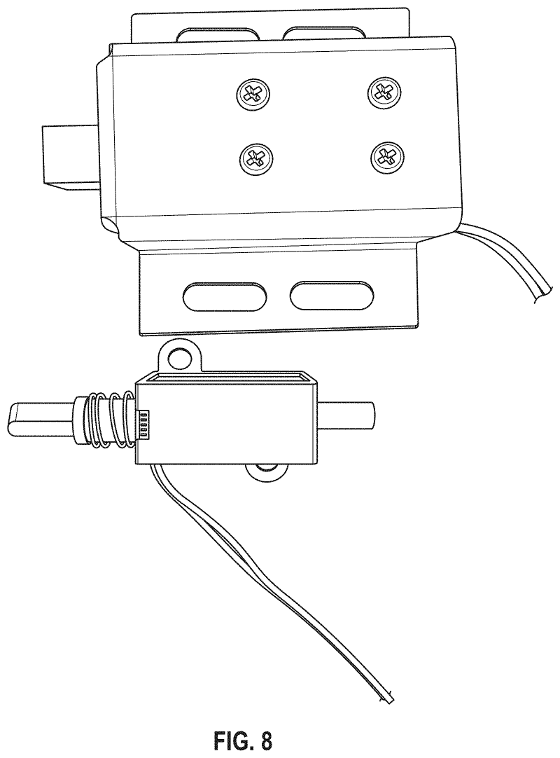

FIG. 9 is an illustration of exemplary components of the linear electromagnetic hardware.

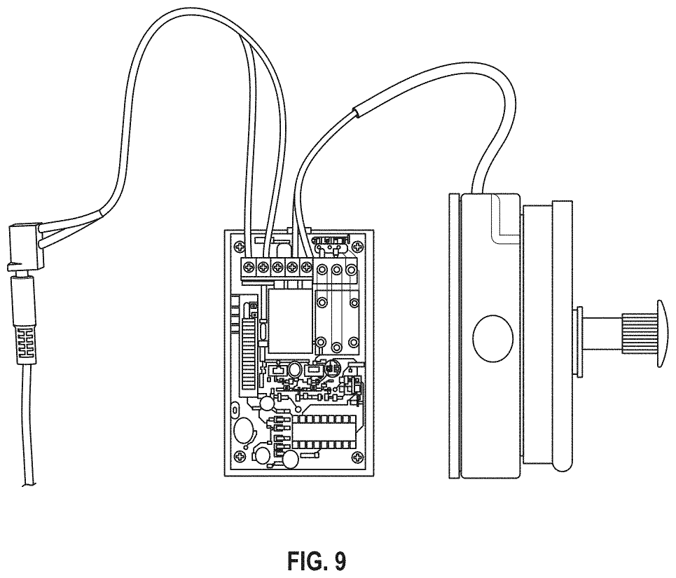

### DESCRIPTION OF WIRELESS CONTROL OF LINEAR ELECTROMAGNETIC ACTUATOR

### Child Proof System

The instant invention is a system for remotely locking and unlocking multiple storage units (e.g. drawers, cabinets) simultaneously or selectively. The storage units can include, for example, cabinet doors and drawers in the kitchen, living room, bathrooms, and so on.

The system comprises a controller, described infra and supra.

The system works via a plurality of electromagnetic locking devices (herein “linear electromagnetic actuators”) coupled to the controller. The system further comprises a remote control unit that is [preferred embodiment] wirelessly coupled to the controller.

The remote control unit allows the user to send instructions to the controller to either simultaneously lock or unlock all the electromagnetic locking devices associated with the controller or facilitate the locking and unlocking of any particular electromagnetic device associated with the controller.

As an alternative to the remote control unit, the controller can also be coupled to a smart device (smartphone, tablet, laptop, and the like) via a mobile App or a tablet/laptop/desktop program. The connection between the smart device and the controller can be then facilitated either by WiFi, Bluetooth, infrared, and other such communication means.

### Two Primary Embodiments

The System is primarily Embodied as a Wired or a Wireless System:

### A. Wired System Embodiment:

In the wired system, the controller is connected to all of the electromagnetic locking devices via wires. Both the controller and the electromagnetic locking devices can have special connectors for facilitating the connections (e.g., snap fit connectors (quick connect/disconnect), using screws for connection, and other appropriate means). The wires can also be soldered. Clamps or glue can be used to properly route the wires to prevent sagging of the wires. The remote control unit, in the wired system, is the only wireless component.

The electromagnetic locking devices have an “indicator light” function to indicate connection, e.g. LEDs. The indication means provides an indication of the electromagnetic locking device's state (e.g. being in a locked or in an unlocked condition). The indication means can also be configured to provide a discrete signal that can be used to indicate the locked or unlocked condition of the electromagnetic locking device on the smart device.

The controller has a receiver that can accept instructions from the remote control unit or the smart device connected the controller. Based on the user's instructions/prompts, the controller then provides appropriate signals for facilitating either simultaneous locking/unlocking of the electromagnetic locking devices or locking/unlocking of any particular electromagnetic locking device.

The power and ground required from the operation of the electromagnetic locking devices is provided by the controller, which is operated via a batter pack or a supply from the main. It is to be noted that the electromagnetic locking devices are not constantly receiving positive current and are activated only after the controller receives a signal that requires the electromagnetic locking device to be locked or unlocked.

Different modes of operations can be configured and provided as options to the users. For example, child lock mode shall lock all the electromagnetic locking devices, whereas a guest mode can be used to keep the electromagnetic locking devices unlocked for a pre-determined time period.

In cases of system failure, an unlocking device can used to unlock the electromagnetic locking devices. Each electromagnetic device shall allow pre-determined movement of the locked elements, e.g., the door or the drawer to allow the insertion of the unlocking device for unlocking the same.

### B. The Wireless System Embodiment

Substantially similar functionality to the above “wired” embodiment, except that the electromagnetic locking devices are wirelessly coupled to the controller. The electromagnetic locking devices are herein battery-operated. It is to be noted that the electromagnetic locking devices are not constantly activated and are activated only after the controller receives a particular signal that requires the electromagnetic locking device to be locked or unlocked.

### DETAILED DESCRIPTION

The Linear Electromagnetic Actuators (FIG. 405) system is designed to operate from low voltage and low wattage AC or DC voltage. The linear electromagnet actuators can be mounted in various ways, they can be mounted to the door, drawer, door or drawer frame or they could be flush mounted in the door or drawer frame. The electrical power for the electromagnets is provided by the Electronic Controller (FIG. 103) when utilizing wired Linear Electromagnetic Actuators. When the linear electromagnet is energized it will pull the shaft in allowing for the door or drawer to open.

The Linear Electromagnetic Actuators are not continuously powered in either position locked or unlocked. They are powered to provide lock or unlock actuation, when power is removed from the Linear Electromagnetic Actuator they will keep the last actuated position until a command is received. They will actuate to new position and be powered down again. The Command for this logic is internal logic of the Electronic Controller the amount of time before electrical power is removed from the Linear Electromagnetic Actuators will depend on application.

System Operation:

The system comprises of electronic controllers, linear electromagnetic actuators, actuator catches, limit/micro switches, wiring, wireless remote controller, a lock/unlock switch, door unlock light, an app on mobile phone, tablet or computer.

First Method: Wired Linear Electromagnetic Actuators

The Linear Electromagnet Actuators (FIG. 101) are electromagnets with a shaft that will be pushed or pulled depending on the polarity of the coil. The polarity will be manipulated to create the push or pull motion to lock or unlock. The Linear Electromagnetic Actuator can be mounted to the kitchen/bathroom cabinet door or drawer by means of screws, bolts, self-adhesive, or some sort of glue. The linear Electromagnetic Actuator may also be mounted to the door or drawer frame. In this method the Linear Electromagnetic Actuator will have wires connected to it that will provide electricity that are connected to the Electronic Controller (FIG. 103), the wires may be secured with some sort of clip, clamp or wire holder that utilizes either self adhesive or screws. The wires that are connected to the Linear Electromagnetic Actuator can be connected to it by means of a connector with quick disconnect i.e. pull

apart connector or a push a tab to release wire. The wires can also be crimped or soldered to existing wires on the linear electromagnetic actuator. The wires that are connected to the Electronic Controller will be connected via a quick disconnect push tab and insert wire, insert wire into clamp style where tightening screw will tighten clamp or a quick disconnect where wires are secured to mating side of connector and can be inserted into electronic controller. The Linear electromagnetic actuator may have a set of contacts built within itself (FIG. 102) a stand alone switch maybe utilized that can be used to provide a visual indication of unlock/lock status when the linear electromagnetic actuator is extended the circuit or path for electricity to flow will be open, when the linear electromagnetic actuator shaft is retracted a path for electricity to flow is complete and provides the mean power and ground to the light to illuminate and also a discrete signal that can be used for the app based indications and control functions.

The power and ground will be supplied by the controller and the wires will be connected to the electronic controller in the same manor as the linear electronic actuator. The lock/unlock light (FIG. 107) can be indicated on the electronic controller that integrated to the unit or an external light can be mounted in a position that is visible using self adhesive or screws. Another function of the contacts in the linear electromagnetic actuator is that in addition to providing a visible indication of lock status it can provide a discrete signal that can be used to show the status of the lock status on an app viewable via mobile phone, tablet or computer.

The Linear Electromagnetic Actuators are not continuously powered in either position locked or unlocked. They are powered to provide lock or unlock actuation, when power is removed from the Linear Electromagnetic Actuator they will keep the last actuated position until a command is received. They will actuate to new position and be powered down again. The Command for this logic is internal logic of the Electronic Controller.

The system is designed to be operable in the event of a power failure or a defect from the system. There will be an unlock tool that can be utilized in the event of power or system failure. There will be predetermined dimensions of how much the door or drawer will be allowed to open in the locked position to allow insertion of the unlock tool to release or retract the linear electromagnetic actuator.

The Electronic Controller (FIG. 407) receives electrical power from either a battery pack or is plugged into a wall outlet (FIG. 402). In the event its connected to a battery pack the batteries can be disposable or rechargeable type.

The Electronic Controller (FIG. 407) contains the circuitry to send electricity to the linear electromagnetic actuators to dictate the polarity of the Linear Electromagnets Actuators to create push or retraction forces on the shaft to lock or unlock it. The Electronic Controller may be programmed with a preset time limit to automatically lock all of the Linear Electromagnetic Actuators or it may have an “off” switch with

variable time delays (Example: 5 mn, 10 mn 30 mn, 1 hr) to lock all of the Linear Electromagnetic Actuators. The electronic controller may have an integral light mounted (FIG. 107) on the case that can illuminate to indicate an unlocked actuator to aide in set up of the system or for troubleshooting. The electronic controller will have an output with either a quick disconnect connector with a push tab to insert or release the wires, a screw type that secures the wire by squeezing them and securing in position. The controller will have a wireless function, a remote control (FIG. 408) can be utilized to lock or unlock the system.

The Electronic controller may utilize wireless signals (FIG. 410) to create commands to lock or unlock the system. The Electronic Controller may be connected to wired or wireless internet network (FIG. 403). The electronic controller may have an integral or external (FIG. 105) antenna to aide in this function. The independent linear electromagnets & micro switches (FIG. 411) used per cabinet door or drawer will be referred to as channels (FIG. 104). The electronic controller will have labels on the case of the unit “Channel 1” “Channel 2” etc. To aide in ease and understandable set up of the system. The Electronic controller may utilize a Lock/Unlock switch (FIG. 106) that is either wired to the controller or utilizes wireless signal (FIG. 406) to provide a command to electronic controller, the wireless lock/unlock switch may utilize a battery (FIG. 409) as source of power.

Second Method of Operation: Wireless Linear Electromagnetic Actuators Lock/Unlock Signal from Electronic Controller.

The Wireless Linear Electromagnet Actuators (FIG. 301) are electromagnets with a shaft that will be pushed or pulled depending on the polarity of the coil. The polarity will be manipulated to create the push or pull motion to lock or unlock. The Linear Electromagnet may also be fitted with an integral permanent magnet to hold shaft in a predetermined position.

The Wireless Linear Electromagnetic Actuator can be mounted to the kitchen/bathroom and desk cabinet door or drawer by means of screws, bolts, self-adhesive, or some sort of glue. The Wireless Linear Electromagnetic Actuator (FIG. 401) may also be mounted to the door or drawer frame.

In this method the Wireless Linear Electromagnetic Actuator will be connected to a battery (FIG. 304) or connected to a power source via wires. The battery for the Wireless Linear Electromagnetic Actuator be consolidated within case of Linear electromagnet actuator or a stand alone battery (FIG. 404). When the Wireless Linear Electromagnetic Actuator receives the command from the Electronic Reciever (FIG. 303) the polarity of the Wireless Linear Electromagnetic Actuator may be manipulated to cause the shaft to move in the desired direction to lock or unlock.

The Wireless Linear Electromagnetic Actuator can be connected to a battery (FIG. 206) or plugged into an outlet it by means of a connector with quick disconnect (FIG. 302) i.e. pull apart connector or a push a tab to release wire. The wires can also be crimped or soldered to existing wires on the Wireless Linear Electromagnetic Actuator.

The Wireless Linear Electromagnetic Actuators are not continuously powered in either position locked or unlocked. They are powered to provide lock or unlock actuation, when power is removed from the Linear Electromagnetic Actuator they will keep the last actuated position until a command is received. They will actuate to a new position and be powered down again. The Command for this logic is internal logic of the Electronic Controller.

The Electronic Controller receives electrical power from either a battery pack (FIG. 304) or is plugged into a wall outlet (FIG. 205). In the even its connected to a battery pack the batteries can be disposable or rechargeable type, and connected via a quick disconnect (FIG. 306).

The Electronic Controller contains the circuitry to send wireless command signal to the wireless linear electromagnetic actuators to dictate the polarity of the wireless linear electromagnets actuators to create push or pull forces on the shaft to lock or unlock it. The Electronic Controller may be programmed with a preset time limit to automatically lock all of the Linear Electromagnetic Actuators or it may have an “off” switch with variable time delays (Example: 5 mn, 10 mn 30 mn, 1 hr) to lock all of the Linear Electromagnetic Actuators. The controller will have a wireless function, a remote control (FIG. 201) can be utilized to lock or unlock the system. The Electronic controller may utilize wireless signal (FIG. 202) to create commands to lock or unlock the system. The electronic controller may have an integral or external antenna (FIG. 305) to aide in this function. The Electronic Controller may utilize a Lock/Unlock Switch that is wired to the controller or a wireless switch

(FIG. 204) that sends signal to the controller, this option would require either battery pack or to be plugged into wall outlet.

The system is designed to be operable in the event of a power failure or a defect from the system. There will be an unlock tool that can be utilized in the event of power or system failure. There will be predetermined dimensions of how much the door or drawer will be allowed to open in the locked position to allow insertion of the unlock tool to release or retract the linear electromagnetic actuator.

### Further Description of the Drawings

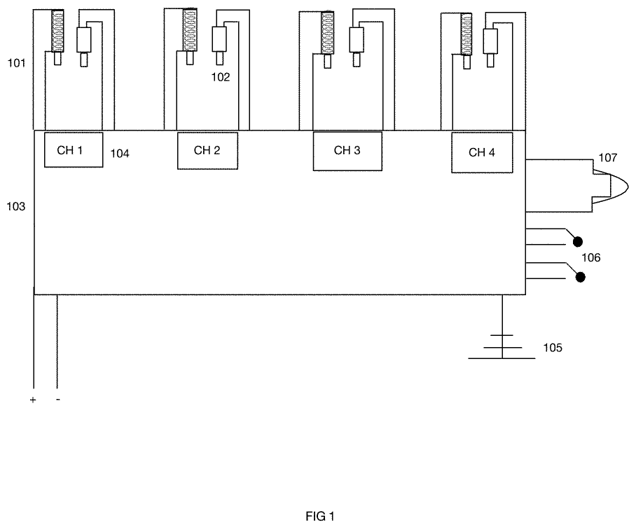

FIG. 1. Overall view of the Wired Linear Electromagnetic Actuators System.
101—depicts the wired linear electromagnetic actuator that is wired to the electronic controller.
102—is the switch that indicates the position to the electronic controller so the electronic controller will know the position of the channel weather is locked or unlocked. The switch is wired to the electronic controller.
103—is the electronic controller which sends the voltage and dictates the polarity of the linear electromagnetic actuators to create movement of the shaft. The controller monitors the position of the switches to give an indication on the mobile phone/tablet / computer app. The electronic controller can be connected to internet network via wife connection or a wired connection.
104—illustrates channels and where to plug in/connect the wires into the electronic controller.
105—is the antenna that is connected to the electronic controller. It can be internal to the electronic controller or external remotely mounted. 106—are the lock/unlock switches depicted in this matter for ease of understanding the system.
107—is the light that indicates if any switch is in the unlock position the light will illuminate to notify the operator there is an unlocked door, drawer, etc. The light can be integral part of the electronic controller with the option of plugging in wires to remotely mount the light.

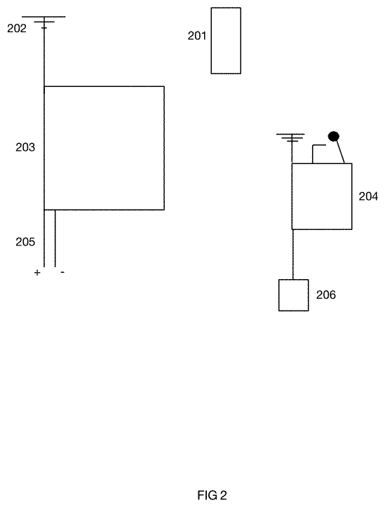

FIG. 2. Depicts the wireless linear actuator system. The wireless linear actuator receives the signal from the electronic controller to lock and unlock the system. It also receives wireless signal with switch position for door/drawer locked or unlocked.
201—is the wireless remote control that can be used to lock or unlock the doors or drawers. The remote control has the ability to lock or unlock individual doors or drawers and also can lock or unlock them simultaneously.
202—is a wireless antenna that can be either integral to the wireless electronic controller or can be an external antenna connected to the wireless electronic controller.
203—is the wireless electronic controller which sends the command wirelessly to the wireless linear actuator electronic receiver, an electronic receiver/transmitter may be utilized if wireless linear actuator has an integral switch. It dictates the polarity of the linear electromagnetic actuators to create movement of the shaft. The wireless electronic controller monitors the position of the switches to give an indication on the mobile phone/tablet/computer app. The wireless

electronic controller can be connected to internet network via wife connection or other sources of wireless connection.
204—illustrates the wireless switch with an integral transmitter to transmit switch of door/drawer position to wireless electronic controller to provide an indication on the apps or the light in the wireless electronic controller.
205—is the power source for the wireless electronic controller, the power source can be a battery or it can be plugged into a wall outlet. 206—is the power source for the wireless switch, the power source can be a battery or it can be plugged into a wall outlet.

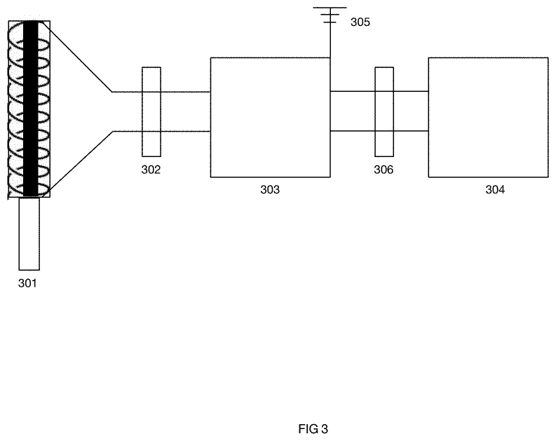

FIG. 3. Depicts the wireless linear electromagnetic actuator, the wireless receiver, battery pack or power source option and the antenna for the wireless receiver.
301—is the linear electromagnetic actuator, it illustrates the shaft that is pushed in or pulled out depending on the polarity of the coil.
302—is the connector that is used to connect the wires from the linear electromagnetic actuator to the wireless receiver.
303—is the wireless receiver that receives the wireless commands from the wireless electronic controller to lock or unlock the doors/ drawers. 304—is the power source for the wireless receiver it can be powered by either a battery or it can be plugged into a wall outlet.

305—is a wireless antenna that can be either integral to the wireless receiver or can be an external antenna connected to the wireless receiver.

306—is the connector that is used to connect the wires from the receiver to the power source.

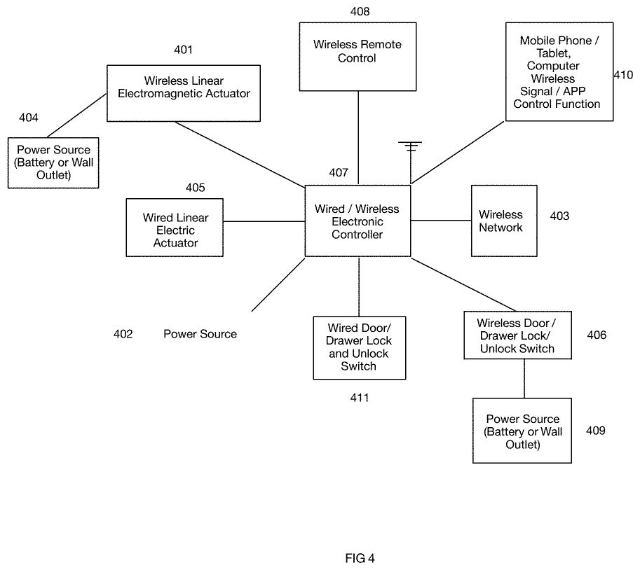

FIG. 4. Is a block diagram that shows the basic overview of both systems. 401—Wireless linear electromagnetic actuator.

402—Power source for wired or wireless Electronic Controller. 403—Wireless Network.

404-Power Source for Wireless Linear Electromagnetic Actuator. 405-Wired

Linear Electric Actuator.

406-Wireless Door/Drawer Lock/Unlock Switch. 407-Wired/Wireless Electronic Controller.

408—Wireless remote control.

409-Power source for wireless door/drawer lock/unlock switch. 410—Mobile phone, tablet, computer wireless signal/app control function.

411—Wired door/drawer lock/unlock switch.

### Further Description of System Hardware—PCB Board, RFID and Connectivity,

### Including Alternate Embodiments

The electronic controller consists of a PCB board that has WiFi antenna. The PCB Board (printed circuit board) has a WiFi Antenna [and depending on the enclosure chosen for the application] the antenna is embedded in the PCB or it can be externally mounted for better signal. The PCB has capability to connect via Bluetooth™ as well.

The PCB Board receives electrical power from either wall outlet 120 V transformed to 5-12 DC voltage. When the signal is received from the app the PCB Board has internal relays that act as control relays that send out voltage out of the PCB into main contactors when the contactor is actuated it sends voltage to the predetermine door or drawer of preference.

There is a predetermined amount of time that is written within the System's App wherein the voltage will remove from the control relay, thus removing power from the voltage thus the latches will go into the lock up position when electrical power is removed because of a spring.

Another embodiment of how the linear electromagnetic actuator are utilized in the unlock position is they are powered unlocked when electrical power is removed a spring/magnet will return them to the lock position.

The PCB can be mounted inside a plastic, metal or hybrid enclosure (combined metal and plastic) the enclosure consists of PCB, wiring, BUS bars, main contactors.

The PCB has inputs for RFID readers on it that can unlock or provide power to the control relay which will provide power to the contactor.

The PCB utilizes an RFID port for wireless transmitter transmitting megahertz (MHz) from wireless remote control that will give the signal via the DOD1 input on the PCB for the RFID.

When the wireless remote is pressed, the control relays will be energized for a predetermined amount of time that is programmable.

The PCB has an input on it to connect a wired switch or “push button” one can use to unlock doors drawers for predetermined amount of time when electrical power will be removed.

The PCB has an input for an alarm, such that when the system is activated and the magnetic switch is utilized for the alarm if it doesn't sense the trigger that the door or drawer is closed, it will send a signal to a horn built into the PCB.

The PCB has a flashing light that serves as indicator light to indicate if it is connected to WiFi (802.11 or other applicable standards).

The PCB has the option of Ethernet LAN connection integrated in that the user can plug to the device to use the their internet instead of WiFi to connect to the App this could potentially be the case when a home is going under renovation or being built.

The number of contacts on PCB will depend on application: in baby proofing in a kitchen it may utilize a PCB with 8-10 control relays where a bathroom lower vanity may use only 1 control relay it all depends on the size.

The control relay provides power to contactor which can provide power to predetermine number of doors, drawers, cabinets, etc.

The electronic controller has a jack style connector for the voltage the voltage we use is low voltage DC.

This PCB has ability to use wireless remote control in addition to using the App. The PCB will also have a USB port to aid in configuration.

The enclosure has a power plug/adaptor female side and we just plug in the power to the adaptor. Depending on the application we may choose to utilize an internal power source.

As another embodiment of the installation, the System uses connectors that push and twist or push and lock with bus wires with positive and negative wires this wires are connected via heat shrink or tie wrap to ease installation and they are color-coded to ease installation. The System runs the wires down the length of the cabinet and the wire will be secured to the back behind the cabinet in some instances depending on access in some instances it will be secured under the counter which will be the preferred method for ease of installation they will be attached to a fastener, Velcro and secured with a screw when allowable.

Regarding the Linear Electromagnetic Actuator, electromagnets will be connected to the BUS wire with a T tap type of wire splice—an instant splice that will not require cutting wires.

In this regard, the linear electromagnetic actuator and the latch will be screwed to the cabinet.

### Disclosure and Specifications Generally

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40%or less than 40%. When, in this specification, a range is given as “(a first number) to (a second number)” or “(a first number)—(a second number),” this means a range whose limit is the second number. For example, 25 to 100 mm means a range whose lower limit is 25 mm and upper limit is 100 mm.

Aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any element in a claim that does not explicitly state “means for” performing a specified function, or “step for” performing a specific function is not to be interpreted as a “means” or “step” clause as specified in 35. U.S.C. § 112 ¶ 6. Specifically, the use of “step of” in the claims herein is not intended to invoke the provisions of U.S.C. § 112 ¶ 6.

1. A system for selectively locking and unlocking a plurality of storage units, the system comprising: a controller; and
a plurality of linear electromagnetic actuator locking devices communicatively coupled to the controller, wherein the controller is configured to facilitate locking and unlocking of at least one said electromagnetic device; and
a remote control unit communicatively coupled to the controller for allowing a user to instruct the controller to trigger the locking and unlocking of said electromagnetic locking device; and
wherein the actuator device functions as or with the storage unit's latch mechanism.

2. The system according to claim 1, wherein the plurality of electromagnet locking devices is communicatively connected to the controller using wires.

3. The system according to claim 1, wherein the plurality of electromagnet locking devices is communicatively connected to the controller using wires, and wherein the wires are connected to the controller using snap fit quick-release [and optional screw- style] connectors.

4. The system according to claim 1, wherein the remote control unit wirelessly coupled to the controller via WiFi, and wherein the storage device is a cabinet.

5. The system according to claim 1, wherein the remote control unit is a smart touchscreen device, wherein an Application is pre-installed in said smart device to interact with the controller.

6. The system according to claim 1, wherein the plurality of electromagnetic locking devices comprises linear or angled solenoid locks, as well as magnetic latch locks.

7. The system according to claim 1, wherein the plurality of electromagnetic locking devices comprises linear or angled solenoid locks, as well as optional magnetic latch locks, and wherein the plurality of electromagnetic locking devices includes an indication light configured to indicate locked/unlocked state of the electromagnetic locking device.

8. The system according to claim 1, wherein the plurality of electromagnetic locking devices is wirelessly coupled to the controller via (inter alia) WiFi wireless networking technology using RF waves to provide wireless high-speed Internet network connection to allow the controller to prompt the locking device.

9. The system according to claim 1, wherein the plurality of electromagnetic locking devices are battery-operated.

10. A system for selectively locking and unlocking a plurality of storage units, the system comprising:
a controller, wherein the controller comprises an optionally WiFi-controlled Printed Circuit Board (PCB), an optional wireless Wiegand system controller; and
a plurality of electromagnetic locking devices communicatively coupled to the controller, wherein the controller is configured to facilitate locking and unlocking of at least one electromagnetic device individually or in combination with at least one another electromagnetic locking device; and
a smart device communicatively coupled to the controller via a user's choice of Ethernet, LAN, WiFi and/or Bluetooth, for allowing said user to instruct the controller using an application pre-installed in said touchscreen smart device for allowing user to trigger the locking and unlocking of the at least one electromagnetic locking device, and wherein the touchscreen smart device is a smartphone, a tablet, or a laptop.

11. The system according to claim 10, wherein the application is configured to facilitate simultaneous or selective locking and unlocking the electromagnetic locking devices for a pre-determined time period using a plurality of operational modes, wherein the pre-determined time period ranges from about 2 seconds to about 2 hours.

12. The system according to claim 10, wherein the application is configured to facilitate simultaneous or selective locking and unlocking the electromagnetic locking devices for a pre-determined time period using a plurality of operational modes, wherein the pre-determined time period ranges from about 2 seconds to about 2 hours, and wherein the wires are connected to the controller using snap fit quick-release [or optionally screw-style] connectors, and wherein the storage unit is a cabinet.

13. The system of to claim 10, wherein the plurality of electromagnetic locking devices comprises at least one solenoid, as well as an optional magnetic latch locks, and wherein said storage unit is a cabinet.

14. The system according to claim 10, wherein the plurality of electromagnetic locking devices includes an indication light configured to indicate locked/unlocked state of the electromagnetic locking device.

15. The system according to claim 10, wherein the plurality of electromagnetic locking devices is wirelessly coupled to the controller and are battery-operated.

16. A system for selectively locking and unlocking a plurality of storage units, the system comprising:
a controller, wherein the controller is a remotely-controlled Printed Circuit Board (PCB), and wherein the controller includes an RFID reader and corresponding ports, and wherein said controller is operable via a wall outlet 120 V transformed to 5-12 DC voltage with an optional/backup battery pack;
said system further comprising
a plurality of battery operated electromagnetic locking devices wirelessly communicatively coupled to the controller, wherein the wireless coupling comprises RFID tags and readers, wherein the controller is configured to facilitate locking and unlocking of at least one electromagnetic device individually or m combination with at least one another electromagnetic locking device; and
a remote control unit communicatively coupled to the controller via RFID tags, Ethernet, LAN, WiFi and Bluetooth, for allowing
the controller to trigger the locking and unlocking of the at least one electromagnetic locking device.

17. The system according to claim 16, wherein the plurality of electromagnetic locking devices includes at least one linear solenoid, as well as optional magnetic latch locks.

18. The system according to claim 16, wherein the plurality of electromagnetic locking devices further comprises an indication light configured to indicate the locked/unlocked state of the electromagnetic locking device, and wherein the electromagnetic device is a component of the storage unit's latch mechanism, and wherein the storage device is a cabinet, and wherein the remote control unit communicates with the controller via WiFi 802.11 standards technology.

19. A system for selectively locking and unlocking a plurality of storage units, the system comprising:
a controller wherein said controller is operable via wall outlet 120 V transformed to 5-12 DC voltage, or optional battery pack; and
a plurality of electromagnetic locking devices communicatively coupled to the controller via wires, wherein the controller is configured to facilitate powering and locking and unlocking of at least one electromagnetic device individually or in combination with at least one another electromagnetic locking device; and
a remote control unit communicatively coupled to the controller for allowing the controller to trigger the locking and unlocking of the at least one electromagnetic locking device.

20. The system according to claim 19, wherein the wires are connected to the controller using screw connectors and optional snap fastening means, and wherein a portion of the wires are optionally bonded via soldering to adjust to a user's custom needs, and wherein the electromagnetic device is the operative component of the latch mechanism of a cabinet such that a child could not open said cabinet without operating said system, and wherein the controller communicates with the electromagnetic device via, inter alia, WiFi 802.11 standards and technology.
